(19) United States
(12) Patent Application Publication
(10) Pub. No.: US 2024/0352318 A1
(43) Pub. Date: Oct. 24, 2024

(54) BIOBASED SURFACTANTS UTILIZING CO2

(71) Applicant: Ohio Soybean Council, Worthington, OH (US)

(72) Inventor: Robert J. Cain, Lewis Center, OH (US)

(21) Appl. No.: 18/617,300

(22) Filed: Mar. 26, 2024

Related U.S. Application Data
(60) Provisional application No. 63/497,925, filed on Apr. 24, 2023.

(51) Int. Cl. C09K 23/16; C09K 23/18; C09K 23/28

(52) U.S. Cl. CPC C09K 23/16; C09K 23/18; C09K 23/28

(57) ABSTRACT

Methods of generating a surfactant composition from natural oil and utilizing greenhouse gas in its manufacture are described. The methods involve the reaction of a lipophilic cyclic carbonate functionalized material with a functionalized amine to form the surfactant. The surfactant has a significant level of biobased carbon content and utilizes either petroleum-derived, biobased, or fermentation-derived greenhouse gas in its manufacture.

### RELATED APPLICATIONS

This application claims priority to U.S. Provisional Patent Application Ser. No. 63/497,925, filed on Apr. 24, 2023, the entirety of which is incorporated herein by reference.

### BACKGROUND

Surface-acting agents or surfactants are used in almost every industry and are of great practical importance in both industry and personal care products. Surfactants are used for antifogging agents, antistatic agents, biocides, corrosion inhibitors, detergents, enhanced oil recovery, fabric pretreatments, paint pigment dispersants, soaps, textile dyeing aids, ionic fluids, mold release agents, personal care products printing aids, and wet strength additives. The use of surfactants has several advantages due to their surface activity and ability to reduce interfacial tension, absorption onto surfaces, and ability to emulsify oils.

US20210139409 describes the use of biobased feedstocks in cationic surfactants. This patent describes a method of generating a cationic surfactant incorporating an ether bond rather than a less stable ester linkage. This may be important in environments where heat and pressure can break down chemical bonds.

EP1068959A1, CN103314025B, U.S. Pat. Nos. 6,358,306, 6,140,412, and 20,080,90949 describe urethanes with cationic functionality. The urethanes are used to aid in the suspension of polymers for coatings. U.S. Pat. No. 8,188,029B2 describes hydrophilic polyurethane foam articles comprising an antimicrobial compound.

Concern about the environmental impact of “greenhouse gases,” such as carbon dioxide, has lead to increasingly restrictive regulations concerning their use and production. Countries around the world are looking into ways to reduce greenhouse gas emissions in many different applications.

There is a need to produce environmentally friendly surfactants which reduce greenhouse gases.

### BRIEF DESCRIPTION OF THE DRAWINGS

FIG. 1 is an illustration of one embodiment of the synthesis of cyclic carbonate from epoxy and carbon dioxide.

FIG. 2 is an illustration of one embodiment of the synthesis of a hydroxy urethane surfactant.

FIG. 3 is an illustration of one embodiment of a hydroxy urethane-co-fatty amide.

FIG. 4 is an illustration of one embodiment of a linear carbonate.

FIG. 5 is an illustration of one embodiment of a quaternization reaction.

FIG. 6 is an illustration of one embodiment of a quaternization reaction with the formation of a zwitterion.

FIG. 7 Is an illustration of one embodiment of a triglyceride surfactant.

### DETAILED DESCRIPTION

The present method of making a surfactant has the advantage of consuming CO₂ via the formation of cyclic carbonates. The use of biobased feedstocks along with the consumption of greenhouse gas is beneficial to the environment. By “biobased,” we mean a renewable resource derived from plants, including, but not limited to, vegetables, pulses, grains, and legumes.

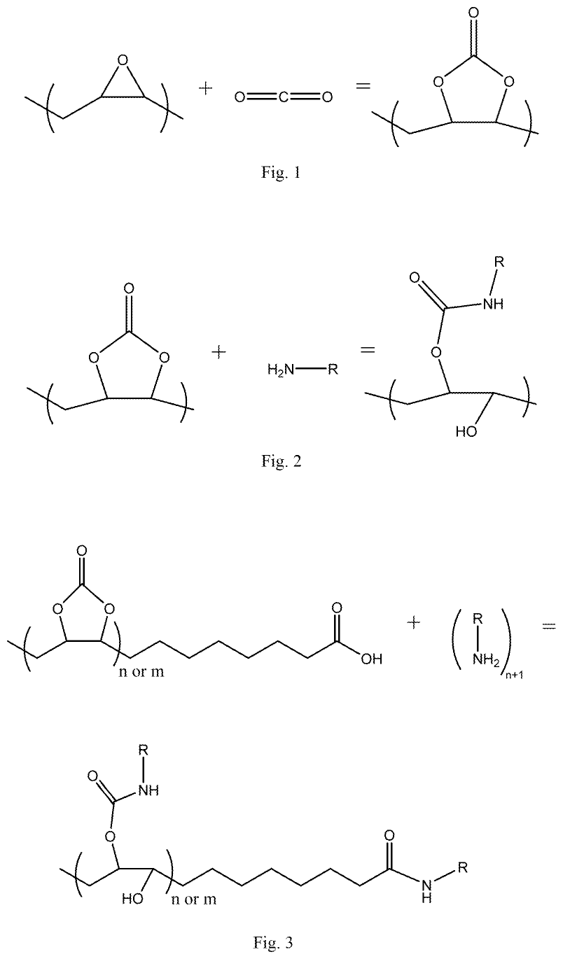

The method of generating cyclic carbonate functionality by CO₂ insertion onto a vicinal diol or epoxy group is illustrated in FIG. 1. One method to conduct the synthesis is to sparge CO₂ gas at temperatures exceeding 100° C. with a phase transfer catalyst, such as tetrabutylammonium bromide (TBAB). Co-catalysts and/or alternative quaternary catalysts can be employed. Utilizing supercritical CO₂ has the advantage of being significantly faster; however, it requires a reaction vessel that can withstand supercritical pressures over 1000 psi.

The carbonated oil is lipophilic. In order to produce a surfactant, incorporation of polar functionality is needed. The basic structure of the present surfactant comprises a hydroxy urethane linkage as illustrated in FIG. 2. R represents hydrophilic chemistry, including, but not limited to hydroxyls, amines, acids, or combinations thereof.

The present application provides a surfactant composition with a hydroxy urethane linkage and a method of preparing the surfactant. The composition is based on bio-based materials, such as plant and animal oils, fatty acids, fatty acid esters, fatty acid amides, or combinations thereof. The synthesis involves the preparation of a cyclic carbonate group which consumes carbon dioxide, a greenhouse gas. These factors make it an environmentally friendly process and product.

Plant and animal oils are abundant natural resources that are cheap and readily available. The triglyceride oils are composed of a mixture of saturated and unsaturated fatty acids. Any suitable plant or animal oils can be used. Suitable plant and animal oils include, but are not limited to, soybean oil, palm oil, olive oil, corn oil, canola oil, coconut oil, cottonseed oil, cashew nutshell liquid, palm kernel oil, rice bran oil, safflower oil, sesame oil, hemp oil, lard, tallow, fish oil, algal oil, and combinations thereof.

For use in the present process, the points of unsaturation in the oils are transformed into cyclic carbonates. In some embodiment, the process may involve prior transitional steps of converting the double bonds in the oils into vicinal hydroxyls (for example) or epoxidizing the oils.

The carbonation of oxirane rings can be performed at temperatures over 100° C. at standard pressure or at supercritical CO₂ conditions. Supercritical CO₂ behaves as both a solvent and a reagent, and it would be an ideal solvent as it would easily separate when brought to standard temperature and pressure. The challenge of using supercritical CO₂ requires temperatures and elevated pressures over the critical point of about 31° C. and 1070 psi. Most epoxy functionalized oils are thin enough when warm not to require a solvent for the carbonatation reaction. Although solvents are not required for the reaction, they can be used. Typical solvents, include, but are not limited to, ethyl acetate, toluene, acetone, methyl ethyl ketone, methyl isobutyl ketone. Ethyl acetate may be most preferable as it is the solvent with the greatest CO₂ solubility.

In some cases, catalysts and co-catalysts can aid in the formation of cyclic carbonates. Metal oxides, metal coordination complexes, and/or phase transfer catalysts are traditional options for catalyzing cyclic carbonate formation with CO₂ from oil with oxirane functionality. Tetrabutylammonium bromide (TBAB), and its other halogenated forms (e.g., iodide, chloride) are effective phase transfer catalysts.

After obtaining a cyclic carbonate functionalized oil, it is reacted with a functionalized amine to produce a hydroxy urethane linkage. The functionalized amine has a first functional group that forms the hydroxy urethane linkage and a second functional group having hydrophilic functionality. The hydrophilic functionality imparts additional polarity to the oil beyond that of the hydroxy group used to form the hydroxy urethane linkage.

In some embodiments, the polar hydrophilic functionality is hydroxyl or ethoxylate.

Examples for (H₂N—R) include, but are not limited to, ethanolamine, aminophenol, 2-amino-2-(hydroxymethyl)-1,3-propanediol, N-(3-aminopropyl) diethanolamine.

In some embodiments, the polar hydrophilic functionality is/are primary amine/s, secondary amine/s, tertiary amine/s, quaternary amine/s, or combinations thereof. Examples of (H2N—R) are not exclusive to ethylene diamine, diethylenetriamine, triethylenetetramine, guanidine, melamine.

After formation of the hydroxy urethane linkage, the primary through tertiary amine form can become cationic via neutralization or ion exchange with acids. There are a wide range of acids that are suitable. Acids containing halogens are common, but they could also contain phosphorus, sulfurous acids, or even organic acids containing carboxylate groups. Examples of acids include, but are not limited to, HCl, HBr, organophosphates, acetic acid, formic acid, lactic, citric, ascorbic, benzoic, and maleic.

In some cases, the quaternary amine form is preferred for pH stability. This would involve converting the tertiary amine to a quaternary amine. For example, the tertiary amine could be reacted with a benzyl halide or an alkyl halide. When an alkyl halide is used, the alkyl group desirably has 8 or fewer carbon atoms.

Amino acids are a good example of primary amine functional organic compounds with additional hydrophilic functionality. Hydrophilic functionality may be additional amine groups, carboxylic acids, or a combination of the two. Examples of amino acids would be alanine, arginine, asparagine, aspartic acid, cysteine, glutamic acid, glutamine, glycine, histidine, isoleucine, lysine, methionine, phenylaniline, proline, serine, threonine, tryptophan, tyrosine, valine. Esters or salts of amino acids could also be used.

Another aspect of the invention is a surfactant. In one embodiment, the surfactant has the general formula:

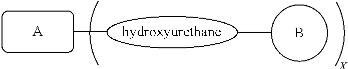

wherein A is some form of natural oil comprising a plant or animal oil or derivative thereof, a triglyceride group, a fatty acid group, a fatty acid ester group, a fatty acid amide group, or combinations thereof; B represents a polar hydrophilic group comprising a hydroxyl, an amine, an acid, or combinations thereof; and x is 1-9.

The polar group is covalently bonded to the oil, fatty acid, etc. by a hydroxyurethane linkage. The functionality of the oil “X” may be 1 or more, and is desirably in the range of 1 to 9. The hydroxyurethane can be either part of the alkyl chain or added to the end of the fatty acid by means of an ester or amide, or a combination of functional triglycerides and fatty acids.

The polarity of the surfactant should be enough to reduce the surface tension of the fluid of which it is dissolved. The fluid is typically water, although other fluids can be used depending on the particular application. Oil-in-water and water-in-oil emulsions require surfactants, for example.

The molecular weight (Mn) of the surfactant is typically in the range of 300 and 4000 g/mol. The surfactant is typically a liquid or a waxy solid.

The surfactant is an additive capable of forming interfacial films. It is not a durable polymer, resin, or coating.

In some embodiments, at least one of R2 groups is an amine. In some embodiments, the amine comprises a primary amine, a secondary amine, or a tertiary amine.

In some embodiments, the amine is modified to be cationic, zwitterionic, or a quaternary amine.

In some embodiments, the surfactant has the formula:

R₁—(NH—C(O)O—R₂)ₓ

wherein R₁ is some form of natural oil comprising a plant or animal oil or derivative thereof, a triglyceride group, a fatty acid group, a fatty acid ester group, a fatty acid amide group, or combinations thereof; R₂ is a polar hydrophilic group comprising a hydroxyl, an amine, an acid, or combinations thereof; and x is 1-9.

In some embodiments, A is a triglyceride, and the surfactant has a formula:

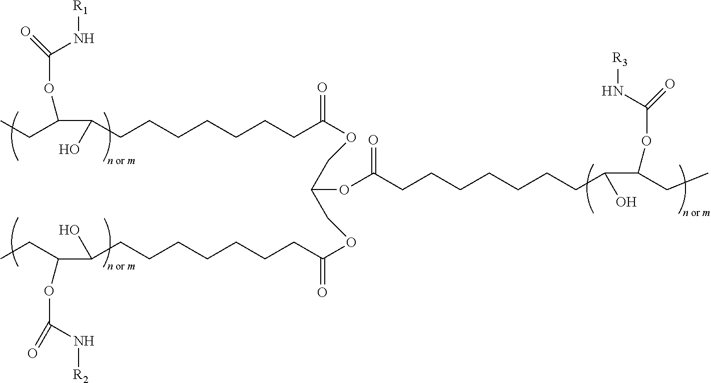

wherein R₁, R₂, and R₃ are independently polar hydrophilic groups comprising a hydroxyl, an amine, an acid, or mixtures thereof; wherein n is an integer from 0 to 3 (representing fully functionalized oleic, linoleic and linolenic acids), and m is 9-3n or when the acid is, m is 6 or 9 (representing non-functionalized palmitic or stearic acids). The triglyceride portion may contain a variety of fatty acid groups as in known in the art, depending on the specific plant or animal oil used.

In some embodiments, n is on average greater than 1.

The oil and the polar group are separated by hydroxyurethane linkages. The amine can be further modified to be cationic, anionic, or zwitterionic.

In some embodiments, A is a fatty acid, and the surfactant has the formula:

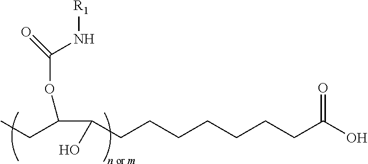

In some embodiments, the fatty acid is functionalized thru the ester, and the surfactant has the formula:

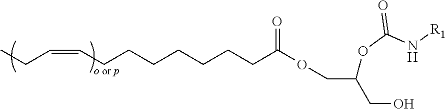

wherein o is an integer from 0 to 3 (representing oleic, linoleic and linolenic acids), and p is 9-30 or when the acid is, p is 6 or 9 (representing palmitic, and stearic acids). This is a linear surfactant, and the functionality is off of the ester. As a result, it does not matter if the fatty acid is saturated or unsaturated. This is sometimes referred to as an AB style surfactant in which one side is dispersive and the other side is polar.

The surfactants can be used alone or in blends of two or more. The surfactants can be used for a variety of applications, including, but not limited to, antifogging agents, antistatic agents, biocides, corrosion inhibitors, detergents, enhanced oil recovery, fabric pretreatments, paint pigment dispersants, soaps, textile dyeing aids, ionic fluids, mold release agents, personal care products printing aids, and wet strength additives.

### Examples

### Example 1: Preparation of Cyclic Carbonated Soybean Oil (CSBO)

To a 1000 mL three-necked round bottom flask, epoxidized soybean oil, tert-butyl ammonium bromide (TBAB), and ground CaCl₂) were added. The flask was equipped with overhead stirring, a CO₂ inlet/outlet, and a thermocouple. The reaction was heated to 110° C., and when 110° C. was reached, a medium flow of CO₂ was introduced. The reaction was monitored via epoxy value. TBAB will contribute to a slightly higher epoxy value, and therefore it may never reach zero. The reaction was allowed to proceed until an oxirane oxygen titration value of less than 0.5 was reached to yield a viscous amber liquid.

### Example 2: Hydroxy Urethane Linkage and Tertiary Amine Generation

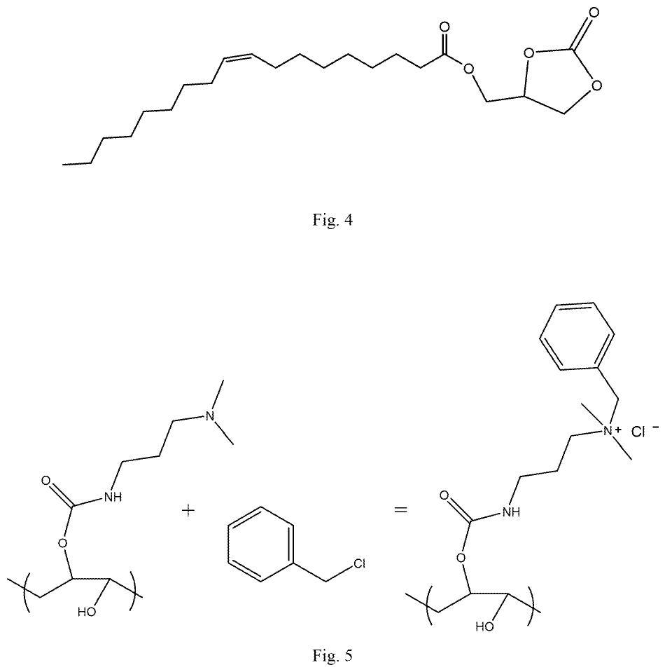

To a 100 mL single-necked round bottom flask CSBO and dimethylaminopropylamine were added. The flask was purged with dry inert argon gas for 5 min. The flask was equipped with magnetic stirring and a thermocouple and placed on a heating mantle on top of a stir plate. The flask was heated to 60° C. and left to stir overnight. The product was characterized via FTIR. FIG. 3 illustrates this reaction.

### Example 3. Surfactant Cation Generation/Counterion Addition

To 20.9 grams of hydroxy urethane tertiary amine product, 9.8 grams of 37% HCl was added and mixed. The resultant product was dispersible in water.

### Example 4. Surfactant Physical Property Evaluation

1.Surface Tension: The surface tension of a 1% surfactant solution of Example 3 was measured quickly by stalagmometry. The surface tension was determined to be 37 dynes/cm, compared to water which is taken to be 72 dynes/cm.

Biobased carbon: The halide salt product sample from example 3 was evaluated by radiocarbon testing and determined to be 57% renewable or biobased carbon.

### Example 5. Linear Surfactant Employing Fatty Acid Ester Vs Triglyceride of Oil

A 100 ml 3-neck round bottom flask fitted with a thermocouple-heating mantle-temperature controller network, overhead stirrer, dry inert argon purge gas, and a Dean-Stark trap with a water-cooled condenser was charged with glycerol carbonate (20 g), soy fatty acid (47 g), zinc acetate (0.31 g), and a small amount of toluene to fill the trap and 10 mL extra to aid in reflux. The reactor was heated to 170° C. and maintained for 8 h under a constant argon purge.

The reaction was monitored via acid value titration and FTIR. The acid value dropped below 10 mg KOH/g, and the FTIR showed a peak shift from 1706 to 1740 cm⁻¹ with the formation of ester.

The resulting linear fatty acid ester illustrated in FIG. 4 could further be converted into a surfactant of a linear AB-type structure. This cyclic carbonate could undergo the same hydroxy urethane synthesis as in the above example and yield a linear surfactant with both polar and dispersive functionalities at either end.

### Example 6: Quaternary Surfactant

A 250 mL round bottom flask was charged with carbonated soybean oil (72.19 g), dimethylaminopropyl amine (26.5 g), and toluene (110 g). The reactor was heated to 110° C. for 2 h while purging with dry inert argon gas, then cooled to 80° C. and left to stir at temp for 64 h. Upon reaction completion, benzyl chloride (32.86 g) was added slowly, and the reaction was heated to 100° C. for 8 h. The product was distilled to isolate the desired solids. The reaction is illustrated in FIG. 5.

### Example 7: Zwitterionic Surfactant

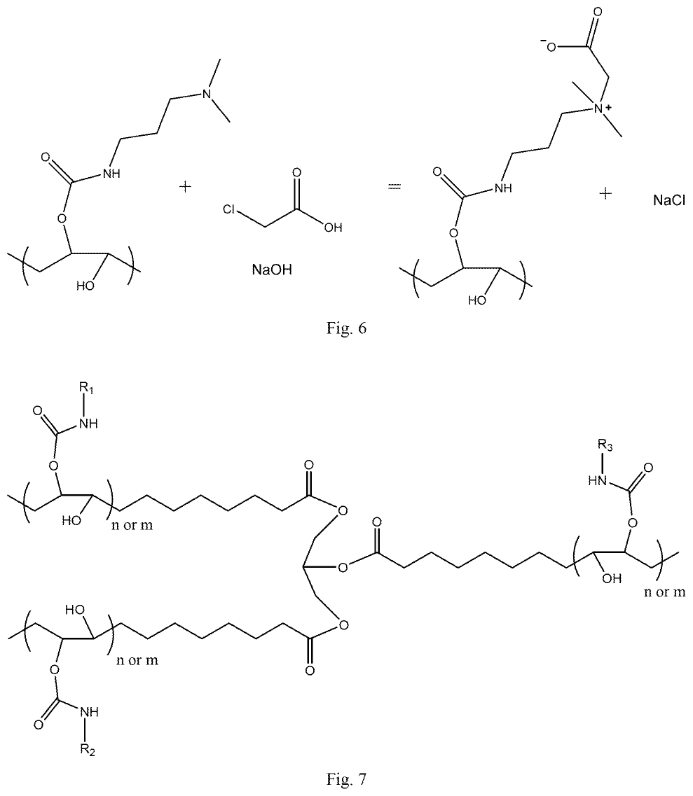

A zwitterionic surfactant containing both cationic and anionic functionality could be made similar to the quaternary surfactant except that instead of benzyl chloride, chloroacetic acid would be substituted at the appropriate molar ratio in an alkaline environment. This reaction is illustrated in FIG. 6.

### Example 8: Anionic Surfactant

A surfactant containing anionic functionality could be made similar to the quaternary surfactant except that instead of benzyl chloride, an amino acid would be substituted at the appropriate molar ratio.

While at least one exemplary embodiment has been presented in the foregoing description of the invention, it should be appreciated that a vast number of variations exist. It should be appreciated that the exemplary embodiments are only examples, and are not intended to limit the scope, applicability, or configuration of the invention in any way. It should be understood that various changes may be made in the function and arrangement of elements and material described in an exemplary embodiment with departing from the scope of the invention as set forth in the claims.

What is claimed is:

1. A method of making a surfactant comprising a hydroxy urethane linkage comprising:
reacting a lipophilic cyclic carbonate functionalized material with a functionalized amine to form the surfactant;
wherein the lipophilic cyclic carbonate functionalized material is derived from a plant or animal oil, a fatty acid, a fatty acid ester, a fatty acid amide, or combinations thereof;
wherein the functionalized amine comprises an amine having a first functional group which forms the hydroxy urethane linkage and a second functional group having hydrophilic functionality.

2. The method of claim 1 wherein the lipophilic cyclic carbonate functionalized material is derived from the plant or animal oil.

3. The method of claim 1 wherein the lipophilic cyclic carbonate functionalized material is derived from soybean oil, palm oil, olive oil, corn oil, canola oil, coconut oil, cottonseed oil, palm kernel oil, rice bran oil, safflower oil, sesame oil, hemp oil, lard, tallow, fish oil, algal oil, their fatty acid esters, amides, or combinations thereof.

4. The method of claim 1 further comprising:
epoxidizing a double bond in the plant or animal oil, the fatty acid, the fatty acid ester, the fatty acid amide, or combination thereof to form an epoxidized material;
reacting the epoxidized material with CO₂ to form the lipophilic cyclic carbonate functionalized material.

5. The method of claim 1 further comprising:
converting a double bond in the plant or animal oil, the fatty acid, the fatty acid ester, the fatty acid amide, or combination thereof to a material having vicinal hydroxyls;
reacting the material having vicinal hydroxyls with CO₂ form the lipophilic cyclic carbonate functionalized material.

6. The method of claim 1 wherein the surfactant is soluble in polar solvents, or non-polar solvents, or both.

7. The method of claim 1 where the hydrophilic functionality comprises a hydroxyl, or an ethoxylate.

8. The method of claim 1 wherein the hydrophilic functionality comprises an amine, a salt of a primary amine, a secondary amine, a salt of a secondary amine, a tertiary amine, a salt of a tertiary amine, a quaternary amine, a salt of a quaternary amine, or combinations thereof.

9. The method of claim 1 wherein the hydrophilic functionality comprises an ethanolamine, a salt of an ethanolamine, an ethylenediamine, a salt of an ethylenediamine, a 1,1,1-Tris(aminoethyl) ethane, a salt of a 1,1,1-Tris(aminoethyl) ethane, or combinations thereof.

10. The method of claim 1 wherein the hydrophilic functionality comprises diethylenetriamine, a salt of diethylenetriamine, triethylenetetramine, a salt of triethylenetetramine, a cyclic polyamine, a salt of a cyclic polyamine, a tris(2-aminoethyl)amine, a salt of a tris(2-aminoethyl)amine, a polyethylenimine, a salt of a polyethylenimine, a poly aziridine, a salt of a poly aziridine, a guanidine, a salt of a guanidine, melamine, a salt of melamine, or combinations thereof.

11. The method of claim 1 wherein the hydrophilic functionality comprises dimethylamino propyl amine, a salt of dimethylamino propyl amine, or combinations thereof.

12. The method of claim 1 further comprising:
reacting a tertiary amine with an organic halide to form an alkyl quaternary amine; and
wherein the hydrophilic functionality comprises the quaternary amine.

13. The method of claim 1 wherein the hydrophilic functionality comprises an amino acid.

14. The method of claim 1 wherein the functionalized amine comprises a primary, secondary, or tertiary amine, and further comprising:
neutralizing the primary, secondary, or tertiary amine; or
reacting the primary, secondary, or tertiary amine with an acid.

15. The method of claim 1 where the hydrophilic functionality is zwitterionic, cationic, anionic, or non-ionic.

16. The method of claim 1 where the second functional group is an acid.

17. A surfactant having a formula: 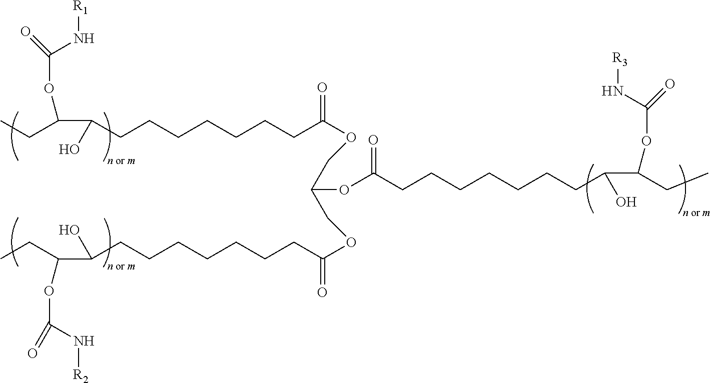
wherein R₁, R₂, and R₃ are independently polar groups comprising a hydroxyl, an amine, an acid, or mixtures thereof; wherein n is an integer from 0 to 3, and m is 9-3n or when the acid is stearic or palmitic acid, m is 9 or 6, wherein the tertiary screen is at a bottom of the burn zone or in the reheat zone.

18. The surfactant of claim 17 wherein at least one of R is the amine.

19. The surfactant of claim 18 wherein the amine comprises a primary amine, a secondary amine, or a tertiary amine.

20. The surfactant of claim 18 wherein the amine is modified to be cationic, zwitterionic, or a quaternary amine.

21. The surfactant of claim 17 wherein n averages greater than 1.

22. A surfactant having a formula 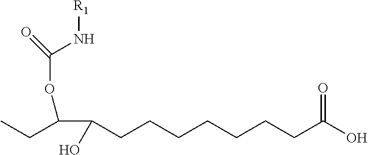
wherein R₁ are independently is a polar groups comprising a hydroxyl, an amine, an acid, or a mixtures thereof; wherein n is typically an integer from 0 to 3.

23. The surfactant of claim 22 wherein at least one of R is the amine.

24. The surfactant of claim 23 wherein the amine comprises a primary amine, a secondary amine, or a tertiary amine.

25. The surfactant of claim 23 wherein the amine is modified to be cationic, zwitterionic, or a quaternary amine.

26. The surfactant of claim 22 wherein n averages greater than 1.

27. A surfactant having a formula 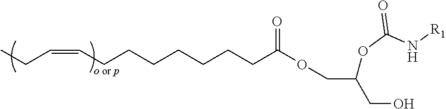
wherein R₁ are independently is a polar groups comprising a hydroxyl, an amine, an acid, or a mixtures thereof; wherein o is typically an integer from 0 to 3, and p is 9-30 or when the acid is stearic or palmitic acid, m is 9 or 6.

28. The surfactant of claim 27 wherein at least one of R is the amine.

29. The surfactant of claim 28 wherein the amine comprises a primary amine, a secondary amine, or a tertiary amine.

30. The surfactant of claim 28 wherein the amine is modified to be cationic, zwitterionic, or a quaternary amine.

31. The surfactant of claim 27 wherein o averages greater than 1.

32. A surfactant having a formula: 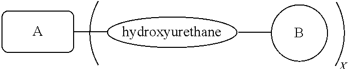
wherein A is natural oil comprising a plant or animal oil or derivative thereof, a triglyceride group, a fatty acid group, a fatty acid ester group, a fatty acid amide group, or combinations thereof; B is a polar hydrophilic group comprising a hydroxyl, an amine, an acid, or combinations thereof; and x is 1-9.

33. The surfactant of claim 32 wherein a molecular weight of the surfactant is between 300 and 4000.

34. The surfactant of claim 32 wherein B comprises the amine.

35. The surfactant of claim 34 wherein the amine comprises a primary amine, a secondary amine, or a tertiary amine.

36. The surfactant of claim 34 wherein the amine is modified to be cationic, zwitterionic, or a quaternary amine.
